(19) United States
(12) Patent Application Publication
(10) Pub. No.: US 2025/0058673 A1
(43) Pub. Date: Feb. 20, 2025

(54) SYSTEM FOR MANAGING THE ELECTRIC POWER FLOW IN BATTERY PACKS OF AN ELECTRIC OR HYBRID VEHICLE

(71) Applicant: Brembo S.p.A., Curno, Bergamo (IT)

(72) Inventors: Carlo CANTONI, Curno, Bergamo (IT); Roberto ARIENTI, Curno, Bergamo (IT); Giacomo URSO, Curno, Bergamo (IT)

(21) Appl. No.: 18/722,652

(22) PCT Filed: Dec. 20, 2022
(86) PCT No.: PCT/IB2022/062533

§ 371 Date: Jun. 21, 2024

(30) Foreign Application Priority Data
Dec. 24, 2021 (IT) 102021000032618

(51) Int. Cl. B60L 58/12; B60L 7/18; B60L 58/18; B60W 20/13; B60W 30/18

(52) U.S. Cl. CPC B60L 58/12; B60L 7/18; B60L 58/18; B60W 20/13; B60W 30/18127

(57) ABSTRACT

A system for managing the electric power flow in battery packs of an electric or hybrid vehicle may have an electronic control unit of the vehicle, the electronic control unit being configured to be operatively connected to at least one first electric motor of a braking/driving system of the vehicle operatively connected to at least one first axle of the vehicle, the electronic control unit being configured to control the at least one first electric motor. The system may also have a power management unit operatively connected to the electronic control unit, the power management unit being configured to be operatively connected to the at least one first electric motor.

### FIELD OF THE INVENTION

The present invention relates to a system for managing the electric power flow in battery packs of an electric or hybrid vehicle.

### BACKGROUND ART

The current architecture of an electric or hybrid vehicle uses high-load batteries, i.e., consisting of energy cells, capable of receiving large amounts of energy in order to maximize the mileage of the vehicle.

In this configuration, a compromise is necessarily reached in the braking regenerating phase, i.e.:
on the one hand, the load (and therefore, the weight) of the high-load battery can be increased, beyond what is strictly required to complete the mission, or;
on the other hand, the power peak in the braking regenerating phase can be limited by having the dissipative brake intervene alongside the regenerating brake, in this case dispersing into heat part of the otherwise recoverable energy.

In the current architecture therefore, the employment of high-load batteries for recovering braking energy allows storing large amounts of energy but dictates strong design limits, as described above.

As a result, the braking power peaks are necessarily dissipated using the dissipative brake, unless the high-energy batteries are excessively oversized.

In light of the above, the need is currently felt to provide an architecture for managing the electric power flow in battery packs of an electric or hybrid vehicle which allows maximizing the recovery of braking power peaks.

### SUMMARY OF THE INVENTION

It is the object of the present invention to devise and provide a system for managing the electric power flow in battery packs of an electric or hybrid vehicle which allows obviating the above-described limits using a hybrid architecture of battery packs consisting of high-energy cells and high-power cells while managing the flows of regenerated power between the two battery sub-systems so as to maximize the recovery of the braking power without providing oversizing of the battery pack.

Such an object is achieved by a system according to claim 1.

Further advantageous embodiments are the subject of the dependent claims.

### BRIEF DESCRIPTION OF THE DRAWINGS

Further features and advantages of the system according to the invention will become apparent from the following description of preferred exemplary embodiments thereof, given by way of non-limiting indication, with reference to the accompanying drawings, in which:

FIGS. 1-3 each show a block diagram of a system for managing the electric power flow in battery packs of an electric or hybrid vehicle according to an embodiment of the present invention;

FIG. 4 shows a functional block diagram of a functional block of a system for managing the electric power flow in battery packs of an electric or hybrid vehicle according to an embodiment of the present invention;

FIG. 5 shows a functional block diagram of a further functional block of a system for managing the electric power flow in battery packs of an electric or hybrid vehicle according to an embodiment of the present invention;

FIG. 6 shows a functional block diagram of a further functional block of a system for managing the electric power flow in battery packs of an electric or hybrid vehicle according to an embodiment of the present invention, and

FIG. 7 shows a functional block diagram of a system for managing the electric power flow in battery packs of an electric or hybrid vehicle according to an embodiment of the present invention.

It is worth noting that equal or similar elements in the figures will be indicated by the same numeric or alphanumeric references.

### DESCRIPTION OF SOME PREFERRED EMBODIMENTS

With reference now to the aforesaid figures, reference numeral 100 indicates as a whole a system for managing the electric power flow in battery packs of an electric or hybrid vehicle, hereinafter also simply control system or simply system, according to the present invention.

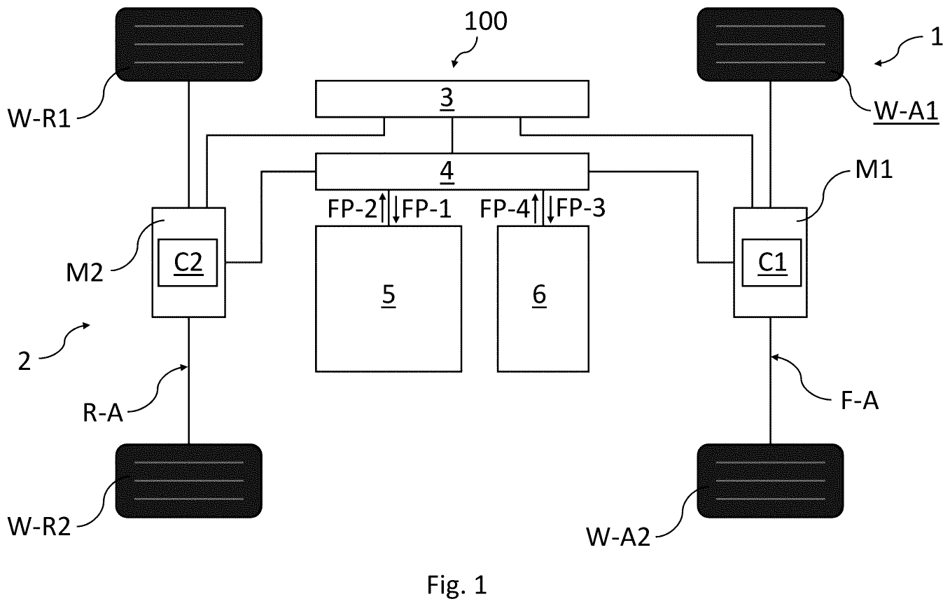

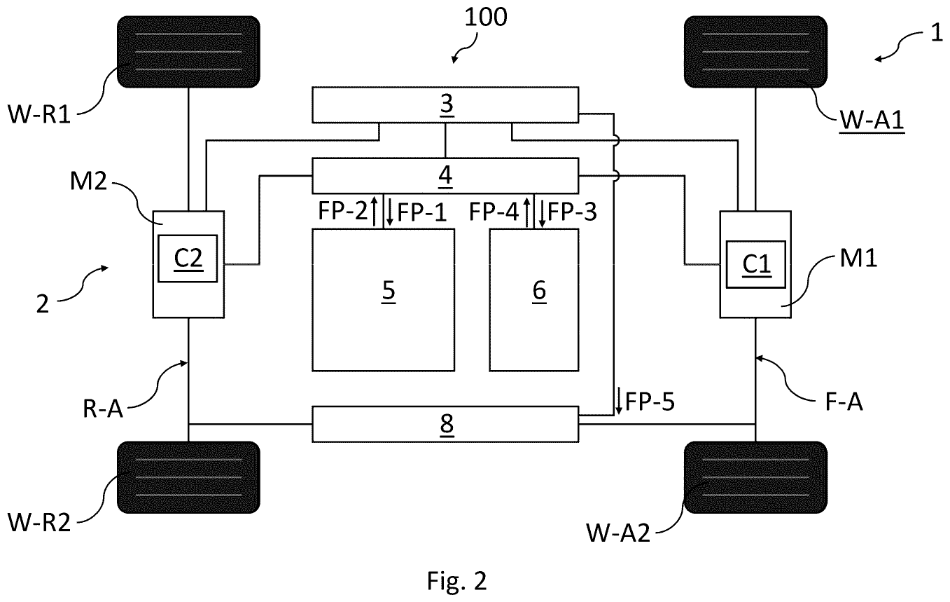

For the purposes of the present description, “vehicle” means any vehicle or motorcycle, also of commercial type or of the racing type, also competitive racing (motorsport), having one, two, three, four, or more wheels, shown only diagrammatically in FIGS. 1-3 and indicated by reference numeral 1.

Furthermore, “braking/driving system” means the whole of all the (mechanical and/or hydraulic and/or electric or electronic) components which contribute to generating the service braking of a vehicle or to generating the parking-braking of a vehicle and the driving of the vehicle.

With reference to FIGS. 1, 2 and 3, the vehicle 1 comprises at least one first axle F-A to which at least one first wheel W-A1 is connected.

The at least one first axle F-A is, for example, a front axle of the vehicle 1, and the first wheel W-A1 is, for example, a front wheel.

According to an embodiment, in combination with the preceding one and shown in FIGS. 1, 2 and 3, the vehicle 1 comprises at least one second wheel W-A2 connected to the first axle F-A.

In this embodiment, the at least one first axle F-A is, for example, a front axle of the vehicle 1, the first wheel W-A1 is, for example, the left front wheel and the at least one second wheel W-A2 is the right front wheel.

In an embodiment, in combination with any of the preceding ones and shown in FIGS. 1, 2 and 3, the vehicle 1 comprises at least one second axle R-A to which at least one further first wheel W-R1 is connected.

In this embodiment, if the at least one first axle F-A is, for example, the front axle of the vehicle 1, the at least one second axle R-A is a rear axle of the vehicle 1, and the at least one further first wheel W-R1 is, for example, a rear wheel.

According to an embodiment, in combination with the preceding one and shown in FIGS. 1, 2 and 3, the vehicle 1 comprises at least one further second wheel W-R2 connected to the at least one second axle R-A.

In this embodiment, if the at least one second axle R-A is the rear axle of the vehicle 1, the at least one further first wheel W-R1 is, for example, the left rear wheel while the at least one second rear wheel W-R2 is, for example, the right rear wheel.

Returning in general to FIGS. 1, 2 and 3, the vehicle 1 further comprises a braking/driving system 2.

The braking/driving system 2 further comprises at least one first electric motor M1 operatively connected to the at least one first axle F-A.

The at least one first electric motor M1 comprises a respective first electric motor control module C1.

The first electric motor control module C1 is configured to control the at least one first electric motor M1 to provide a regenerative braking or driving torque required by the system 100 based on a command received.

The first electric motor control module C1 is, for example, a specially configured hardware module or a software logic present in a main hardware module of the braking/driving system 2 or more generally, in a hardware module of the vehicle 1.

In an embodiment, in combination with the preceding one and in combination with any of the preceding ones where the vehicle 1 comprises the at least one second axle R-A, the braking/driving system 2 further comprises at least one second electric motor M2 operatively connected to the at least one second axle R-A (FIGS. 1-3).

The at least one second electric motor M2 comprises a respective second electric motor control module C2.

The second electric motor control module C2 is configured to control the at least one second electric motor M2 to provide a regenerative braking or driving torque required by the system 100 based on a command received.

The second electric motor control module C2 is, for example, a specially configured hardware module or a software logic present in a main hardware module of the braking/driving system 2 or more generally, in a hardware module of the vehicle 1.

According to a further embodiment (not shown in the figures), alternatively to that in which the braking/driving system 2 of the vehicle 1 comprises the at least one first electric motor M1 operatively connected to the at least one first axle F-A, the braking/driving system 2 comprises at least one first electric motor M1 operatively connected to the first wheel W-A1 (front wheel).

In a further embodiment (not shown in the figures) and in combination with the preceding one, the vehicle 1 comprises a further first electric motor operatively connected to the second wheel W-A2.

In this embodiment, the at least one first wheel W-A1 and the second wheel W-A2 are connected to the at least one first axle F-A, for example, as left front wheel (W-A1) and right front wheel (W-A2).

Also in this embodiment, the further first electric motor is adapted to provide a regenerative braking or driving torque required by the system 100 based on a command received.

In an embodiment (not shown in the figures), alternatively to that in which the braking/driving system 2 of the vehicle 1 comprises the at least one second electric motor M2 operatively connected to the at least one second axle R-A, the braking/driving system 2 comprises at least one second electric motor operatively connected to the further first wheel W-R1 (rear wheel).

In a further embodiment (not shown in the figures) and in combination with the preceding one, the vehicle 1 comprises a further second electric motor operatively connected to the further second wheel W-R2.

In this embodiment, the further first wheel W-R1 and the further second wheel W-R2 are connected to the at least one second axle R-A, for example, as left rear wheel (W-R1) and right rear wheel (W-R2).

Also in this embodiment, the further second electric motor is adapted to provide a regenerative braking or driving torque required by the system 100 based on a command received.

Returning in general to FIGS. 1, 2 and 3, the system 100 comprises an electronic control unit 3 of the vehicle 1 (or vehicle control unit), VCU, which will be described in detail below with reference to other figures as well.

The electronic control unit 3 is, for example, a specially configured hardware module or a software logic present in a main hardware module of the braking/driving system 2 or more generally, in a hardware module of the vehicle 1.

The electronic control unit 3 is configured to be operatively connected to at least one first electric motor M1 of the braking/driving system 2 of the vehicle 1, operatively connected to the at least one first axle F-A of the vehicle 1.

The electronic control unit 3 is configured to control the at least one first electric motor M1, therefore the first front axle F-A.

In greater detail, in an embodiment (shown in FIGS. 1-3), the electronic control unit 3 is directly connectable to the at least one first electric motor M1.

In an embodiment, in combination with the preceding one or with those in which there is the at least one second electric motor 2 operatively connected to the at least one second axle R-A, the electronic control unit 3 is further configured to be operatively connected to the at least one second electric motor M2, of the braking/driving system 2 of the vehicle 1, operatively connected to the second rear axle R-A.

In this embodiment, the electronic control unit 3 is further configured to control the at least one second electric motor M2, therefore the second rear axle R-A.

In greater detail, in an embodiment (shown in FIGS. 1-4), the electronic control unit 3 is further directly connectable to the at least one second electric motor M2.

With reference again in general to FIGS. 1, 2 and 3, the system 100 further comprises a power management unit 4, or PMS, which will be described in detail below.

The power management unit 4 is operatively connected to the electronic control unit 3.

Moreover, the power management unit 4 is configured to be operatively connected to the at least one first electric motor M1.

The system 100 further comprises a first battery pack 5 of high-energy cells (hereinafter also simply first battery pack 5) operatively connected to the power management unit 4.

The first battery pack 5 of high-energy cells is configured to store electricity during a braking phase of the vehicle 1, even in large amounts, to be supplied to the at least one first electric motor M1 during a driving phase of the vehicle 1.

The system 100 further comprises a second battery pack 6 of high-power cells (hereinafter also simply second battery pack 6) operatively connected to the power management unit 4.

In greater detail, the second battery pack 6 of high-power cells is configured to store electricity from electric power peaks of regenerative braking.

According to a possible, non-limiting sizing strategy, the second battery pack 6 of high-power cells comprises a plurality of power cells sized considering the regenerative braking phase of the vehicle 1.

According to a possible, non-limiting sizing strategy, the second battery pack 6 of high-power cells is sized to absorb a maximum electric current equal to the maximum regenerated electric current minus the maximum electric current absorbable by the first battery pack 5 of high-energy cells.

The electricity to be stored in the second battery pack 6 of high-power cells can be delivered to the at least one first electric motor M1 to support the driving phase, or is transferable to the first battery pack 5 of high-energy cells, respecting the maximum electric current limit which the first battery pack 5 of high-energy cells is capable of absorbing.

In an embodiment, in combination with the preceding one or with those in which there is the at least one second electric motor 2 operatively connected to the at least one second axle R-A, the power management unit 4 is configured to be operatively connected to the at least one second electric motor M2.

In this embodiment, the first battery pack 5 of high-energy cells is configured to store electricity during a braking phase of the vehicle 1, even in large amounts, to be supplied to the at least one first electric motor M1 and/or the at least one second electric motor M2 during a driving phase of the vehicle 1.

According to this embodiment, the electricity to be stored in the second battery pack 6 of high-power cells during the braking phase of the vehicle 1 can be delivered to the at least one first electric motor M1 and/or to the at least one second electric motor M2 to support the driving phase, or is transferable to the first battery pack 5 of high-energy cells, respecting the maximum electric current limit which the first battery pack 5 of high-energy cells is capable of absorbing.

According to an embodiment and according to a possible non-limiting sizing strategy, in combination with any one of those described above, the first battery pack 5 of high-energy cells comprises a plurality of energy cells sized considering the driving phase of the vehicle 1, in which the at least one first electric motor M1 (and the at least one second electric motor M2, when present), actually operates as a motor, developing a driving torque which allows the vehicle 1 to advance.

It should be noted that thereby, the first battery pack 5 of high-energy cells, by way of example, can be sized to sustain the electric currents required during the driving phase, in the condition of minimum operating voltage, i.e., that condition in which the electric currents are higher, and therefore are dimensioning, power being equal.

According to a further embodiment, as an alternative to the preceding one, the first battery pack 5 of high-energy cells comprises a plurality of fuel cells.

The plurality of fuel cells is an electrochemical device which allows obtaining electricity through a chemical process involving hydrogen and oxygen, without any combustion process occurring. In fuel cells, the conversion of chemical energy into electricity occurs by combining a negative electrode, or anode (hydrogen), with a positive one, or cathode (oxygen), put into contact with a suitable ion conduction means, or electrolyte.

Returning in general to FIGS. 1, 2 and 3, as it will be reiterated below, the power management unit 4 is configured to provide instructions for conveying flows of electric power entering in and leaving the first battery pack 5 of high-energy cells and the second battery pack 6 of high-power cells and between the first battery pack 5 of high-energy cells and the second battery pack 6 of high-power cells based on a condition of correct operation of the first battery pack 5 of high-energy cells and the second battery pack 6 of high-power cells.

“Condition of correct operation” of the first battery pack 5 of high-energy cells and the second battery pack 6 of high-power cells means the “state of health” of the first battery pack 5 of high-energy cells and the second battery pack 6 of high-power cells, i.e., the state of operating parameters of the first battery pack 5 of high-energy cells and the second battery pack 6 of high-power cells, such as for example the respective state of electric charge, the respective state of voltage, the respective operating temperature, and so on.

The power management unit 4 is, for example, a specially configured hardware module or a software logic present in a main hardware module of the braking/driving system 2 or more generally, in a hardware module of the vehicle 1.

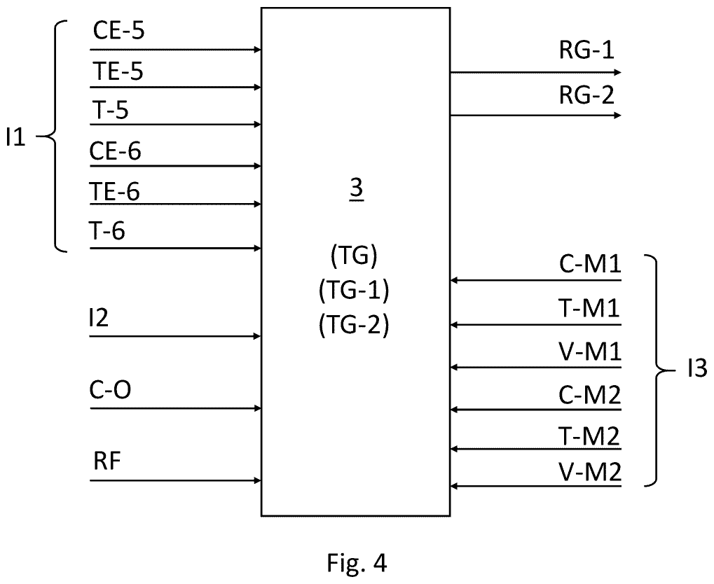

From a functional viewpoint, with reference now also to FIG. 4, the electronic control unit 3 is configured to receive a braking or driving request RF.

The braking or driving request RF can be imparted by a driver P1 by means of one or more pedals of the vehicle 1 (for example, the brake pedal for a braking request or the accelerator pedal for a driving request) or in an automatic manner P2, for example, by a vehicle driver assistance software logic, an automatic autonomous driving/braking logic, and so on.

A braking request is preferably provided to the electronic control unit 3 following the processing carried out by a stroke/pressure sensor of a brake pump (not shown in the figures) of the braking/driving system 2.

A driving request is preferably provided to the electronic control unit 3 following the processing, for example, carried out by a stroke sensor (not shown in the figures) of the vehicle 1.

In an embodiment, in combination with the preceding one, the electronic control unit 3 can be configured to receive at least one piece of information C-O representative of an operating condition of the vehicle 1.

Information representative of an operating condition of the vehicle 1 means the set of one or more operating parameters of the vehicle 1 such as for example speed, acceleration and/or deceleration, and so on.

In this regard, the at least one piece of information C-O representative of an operating condition of the vehicle 1 can comprise, for example, one or more of:
actual speed of the vehicle 1;
acceleration of the vehicle 1;
deceleration of the vehicle 1.

The at least one piece of information representative of an operating condition of the vehicle 1 can be provided by one or more sensors distributed in the vehicle 1 and/or determined by the electronic control unit 3.

Returning in general to the electronic control unit 3, the electronic control unit 3 is further configured to receive first input information I1 representative of a condition of correct operation (“state of health”) of the first battery pack 5 of high-energy cells and the second battery pack 6 of high-power cells.

In this regard, the first input information I1 can comprise, for example, one or more of:
state of electric charge CE-5 of the first battery pack 5 of high-energy cells;
voltage value TE-5 of the first battery pack 5 of high-energy cells;
operating temperature T-5 of the first battery pack 5 of high-energy cells;
state of electric charge CE-6 of the second battery pack 6 of high-power cells;
voltage value TE-6 of the second battery pack 6 of high-power cells;
operating temperature T-6 of the second battery pack 6 of high-power cells.

The first input information I1 is also provided to the electronic control unit 3 by the power management unit 4.

The electronic control unit 3 is further configured to receive at least one second input information I2 representative of an electric power regenerated inside the system 100.

The at least one second input information I2 is provided by the power management unit 4.

The electronic control unit 3 is further configured to receive third input information I3 representative of a regenerative braking or driving phase carried out by the system 100 on the braking/driving system 2.

By way of example, the third input information I3 comprises at least one or more of:
actual value of regenerative braking or driving torque C-M1 generated by the at least one first electric motor M1;
actual temperature value T-M1 of the at least one first electric motor M1;
rotation speed V-M1 of the at least one first electric motor M1.

The third input information I3 can be provided by respective sensors distributed in the braking/driving system 2 and/or are determined by the electronic control unit 3.

The electronic control unit 3 is configured to determine a target braking or driving value TG to be imparted to the vehicle 1, based on said braking request RF.

In an embodiment, in combination with the preceding one and with that in which the electronic control unit 3 receives the at least one piece of information C-O representative of an operating condition of the vehicle 1, the electronic control unit 3 is configured to determine the target braking or driving value TG to be imparted to the vehicle 1 based on said braking request RF and the at least one piece of information C-O representative of an operating condition of the vehicle 1.

In general, the determined target braking or driving value TG to be imparted to the vehicle 1 comprises at least one first regenerative braking or driving torque target RG-1 to be imparted to the at least one first axle F-A.

The electronic control unit 3 is configured to define the at least one first regenerative braking or driving torque target RG-1 to be imparted to the at least one first electric motor M1 operatively connected to the at least one first axle F-A of the vehicle 1 based on said first input information I1, the at least one second input information I2, and said third input information I3.

The target braking or driving value TG to be imparted to the at least one first axle F-A comprises at least one first regenerative braking or driving torque target RG-1.

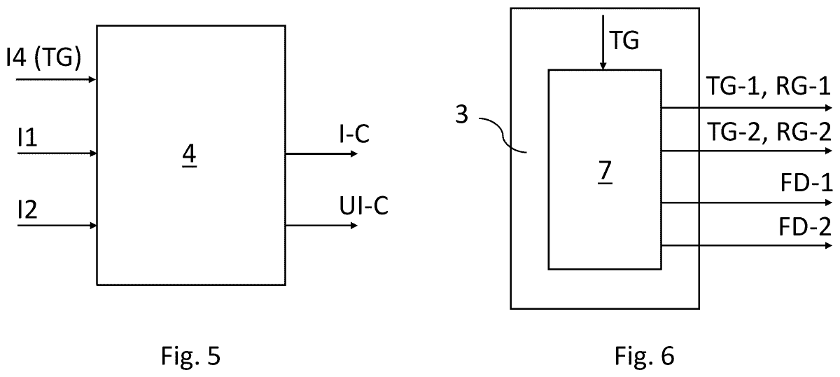

From an operating viewpoint, as shown in FIG. 5, the power management unit 4 is configured to receive a further input information 14 representative of an electric power regenerated by the at least one first electric motor M1.

The further information 14 representative of an electric power regenerated by the at least one first electric motor M1 allows the power management unit 4 to correctly convey the flows of electric power entering in and leaving the first battery pack 5 of high-energy cells and the second battery pack 6 of high-power cells, and between the first battery pack 5 of high-energy cells and to the second battery pack 6 of high-power cells.

In this regard, the power management unit 4 is configured to provide instructions I-C for conveying a first electric power flow FP-1 entering in the first battery pack 5 of high-energy cells, a second electric power flow FP-2 leaving the first battery pack 5 of high-energy cells, a third electric power flow FP-3 entering in the second battery pack 6 of high-power cells, and a fourth electric power flow FP-4 leaving the second battery pack 6 of high-power cells, and control the first electric power flow FP-1, the second electric power flow FP-2, the third electric power flow FP-3, and the fourth electric power flow FP-4 based on said first input information I1, the at least one second input information I2, said third input information I3, and the further input information 14.

It should be noted that the first electric power flow FP-1 and the second electric power flow FP-2 are conveyed on a same physical path, while the third electric power flow FP-3 and the fourth electric power flow FP-4 are conveyed on a same physical path.

The conveying instructions I-C are information generated as a function of the first input information I1 representative of a condition of correct operation (“state of health”) of the first battery pack 5 of high-energy cells and the second battery pack 6 of high-power cells.

In greater detail, the power management unit 4 is configured to correctly deliver electricity to the first battery pack 5 of high-energy cells and/or to the second battery pack 6 of high-power cells during a regenerative braking phase of the vehicle 1 and/or during a driving phase.

Moreover, the power management unit 4 is configured to transfer electricity from the second battery pack 6 of high-power cells to the first battery pack 5 of high-energy cells or transfer electricity directly to the at least one first electric motor M1 and to the at least one second electric motor M2 during the driving phase of the vehicle 1.

Thereby, the second battery pack 6 of high-power cells advantageously supports the first battery pack 5 of high-energy cells during the driving phase.

In an embodiment, in combination with the preceding ones, the electronic control unit 3 is configured to receive the further input information 14 from the power management unit 4.

In this embodiment, based on the further information 14, the electronic control unit 3 is configured to establish the extent of the regeneration, i.e., the extent of the regenerative braking or driving torque imparted to the at least one first electric motor M1 operatively connected to the at least one first axle F-A of the vehicle 1.

In an embodiment, in combination with any of the preceding ones and in which the vehicle 1 comprises the at least one second axle R-A and the braking/driving system 2 of the vehicle 1 comprises the at least one second electric motor M2, the third input information I3 representative of a regenerative braking or driving phase carried out by the system 100 on the braking/driving system 2 further comprises, for example, one or more of:
actual value of regenerative braking or driving torque C-M2 generated by the at least one second electric motor M2;
actual temperature value T-M2 of the at least one second electric motor M2;
rotation speed V-M2 of the at least one second electric motor M2.

Moreover, in this embodiment, the further input information 14 which can be received by the power management unit 4 and possibly also by the electronic control unit 3 is representative of the electric power regenerated by the at least one first electric motor M1 and of an electric power regenerated by the at least one second motor M2.

In this embodiment, the electronic control unit 3 is configured to divide the determined target braking or driving value TG into a first braking or driving component TG-1 to impart to the at least one first axle F-A (for example, the front axle) and into a second braking or driving component TG-2 to be imparted to the at least one second axle R-A (for example, the rear axle) based on said first input information I1, the at least one second input information I2 and said third input information I3.

The first braking or driving component TG-1 to be imparted to the at least one first axle F-A comprises the at least one first regenerative braking or driving torque target RG-1.

The second braking or driving component TG-2 to be imparted to the at least one second axle R-A comprises the at least one second regenerative braking or driving torque target RG-2.

In this embodiment, the electronic control unit 3 is configured to provide the first braking or driving torque component TG-1 to the at least one first electric motor M1 operatively connected to the at least one first axle F-A and the second braking or driving torque component TG-2 to the at least one second electric motor M2 operatively connected to the second axle R-A.

In an embodiment, in combination with the preceding one and in which the electronic control unit 3 is configured to receive the further input information 14 from the power management unit 4, based on the further information 14, the electronic control unit 3 is configured to establish the extent of the regeneration, i.e., the extent of the regenerative braking or driving torque imparted to the at least one first electric motor M1 operatively connected to the at least one first axle F-A of the vehicle 1 and the extent of the regenerative braking or driving torque imparted to the at least one second electric motor M2 operatively connected to the at least one second axle R-A of the vehicle 1.

According to an embodiment, shown in FIG. 6, the electronic control unit 3 comprises a first braking or driving torque division management sub-module 7.

In the more general embodiment, in which the vehicle 1 comprises the at least one first axle and the braking/driving system 2 of the vehicle 1 comprises the at least one first electric motor M1, the first braking or driving torque division management sub-module 7 is configured to define the at least one first regenerative braking or driving torque target RG-1 from the target braking or driving value TG to be imparted to the at least one first axle F-A.

In an embodiment, in combination with the preceding one and in the event the vehicle 1 comprises the at least one second axle R-A and the braking/driving system 2 of the vehicle 1 comprises the at least one second electric motor M2, the first braking or driving torque division management sub-module 7 is configured to divide the target braking or driving value TG into the first braking or driving component TG-1 to be assigned to the at least one first axle F-A and into the second braking or driving component TG-2 to be assigned to the at least one second axle R-A.

In this embodiment, the first braking or driving torque division management sub-module 7 is further configured to define the at least one first regenerative braking or driving torque target RG-1 from the first braking or driving component TG-1 to be imparted to the at least one first axle F-A (for example, the front axle).

Moreover, the first braking or driving torque division management sub-module 7 is configured to define the at least one second regenerative braking or driving torque target RG-2 from the second braking or driving component TG-2 to be imparted to the at least one second axle R-A (for example, the rear axle).

In an embodiment, in combination with any one of those described above, the system 100 further comprises a dissipative braking torque actuation module 8 operatively connected to the electronic control unit 3.

The dissipative braking torque actuation module 8 is configured to be operatively connected to the at least one first axle F-A.

In an embodiment, in combination with the preceding one, the electronic control unit 3 is configured to divide the target braking or driving value TG to be imparted to the at least one first axle F-A into the first regenerative braking or driving torque target RG-1 to be imparted to the at least one first axle F-A by means of the at least one first electric motor M1, and into a first dissipative braking torque target FD-1 to be imparted to the first front axle F-A by means of the dissipative braking torque actuation module 8.

In an embodiment, in combination with the preceding one when in combination with that in which the electronic control unit 3 comprises the first braking or driving torque division management sub-module 7, the division of the target braking or driving value TG to be imparted to the at least one first axle F-A in the at least one first regenerative braking or driving torque target RG-1 and into the first dissipative braking torque target FD-1 is carried out by the first braking or driving torque division management sub-module 7.

In an embodiment, in combination with the preceding one and in which the vehicle 1 comprises the at least one second axle R-A and the braking/driving system 2 of the vehicle 1 comprises the at least one second electric motor M2, the dissipative braking torque actuation module 8 is configured to be operatively connected to the at least one first axle F-A and/or the at least one second axle R-A.

In this embodiment, the electronic control unit 3 is further configured to divide the second braking or driving component TG-2 to be imparted to the at least one second axle R-A into the at least one second regenerative braking or driving torque target RG-2 to be imparted to the at least one second axle R-A by means of the at least one second electric motor M2 and into a second dissipative braking torque target FD-2 to be imparted to the at least one second axle R-A by means of the dissipative braking torque actuation module 8.

It should be noted that the type of first dissipative braking torque target FD-1 and second dissipative braking torque target FD1, when present, depends on the type of dissipative braking torque actuation module 8, as described below according to various embodiments.

In an embodiment, in combination with the preceding one when the electronic control unit 3 comprises the first braking torque division management sub-module 7, the division of the second braking or driving component TG-2 to be imparted to the at least one second axle R-A in the at least one second regenerative braking or driving torque target RG-2 to be imparted to the at least one second axle R-A by means of the at least one second electric motor M2 and into the at least one second dissipative braking torque target FD-2 to be imparted to the at least one second axle R-A by means of the dissipative braking torque actuation module 8 is carried out by the first braking torque division management sub-module 7.

In an embodiment, in combination with any of the preceding ones in which the dissipative braking torque actuation module 8 is provided, the dissipative braking torque actuation module 8 comprises one or more braking modules with B-b-W technology.

Therefore, the dissipative braking torque actuation module 8 (diagrammatically shown as a single block in the figures) comprises at least one brake pump, at least one electromechanical or electrohydraulic actuator, at least one brake assembly (i.e., the brake caliper, brake disc, pad(s) assembly), at least one hydraulic pipe assembly for connecting the aforesaid components to one another. In this embodiment, the dissipative braking torque actuation module 8 is therefore configured to dissipate the braking energy into heat, which is not recovered as in the case of a generator.

In this embodiment, the type of the first dissipative braking torque target FD-1 and the second dissipative braking torque target FD1, when present, is a value of electric current/braking torque.

In an embodiment, in combination with any of the preceding ones in which there is the dissipative braking torque actuation module 8, in addition to providing instructions I-C for conveying a first electric power flow FP-1 entering in the first battery pack 5 of high-energy cells, a second electric power flow FP-2 leaving the first battery pack 5 of high-energy cells, a third electric power flow FP-3 entering in the second battery pack 6 of high-power cells, and a fourth electric power flow FP-4 leaving the second battery pack 6 of high-power cells, and controlling the first electric power flow FP-1, the second electric power flow FP-2, the third electric power flow FP-3, and the fourth electric power flow FP-4, the power management unit 4 is configured to provide further instructions UI-C for conveying a respective fifth electric power flow FP-5 entering in the dissipative braking torque actuation module 8 by means of the electronic control unit 3, and optionally control the fifth electric power flow FP-5 based on said first input information I1, the at least one second input information I2, said third input information I3, and the further input information 14.

In a further embodiment, as an alternative to the preceding one, the

dissipative braking torque actuation module 8 comprises one or more parasitic electric current brakes configured to be operatively connected to the at least one first axle F-A and/or to the at least one second axle R-A (when present) and/or to said at least one first wheel W-A1 and/or said at least one second wheel W-A2 (when present) and/or the further first wheel W-R1 (when present) and/or the further second wheel W-R2 (when present).

The parasitic electric current brake is a magnetic brake which action decelerates the vehicle 1, generating parasitic electric currents by electromagnetic induction. The parasitic current brake is a dissipative brake in which the dissipation of energy is not due to contact between the braking components (as occurs, for example, in a braking module with B-b-W technology), rather to the transformation into heat of the induced braking electric currents. Therefore, also in this case, as in a conventional hydraulic brake, the braking energy is dissipated into heat and is not recovered, as in the case of a generator.

Therefore, advantageously, the system 100 according to this embodiment is not subject to wear.

In this embodiment, the type of first dissipative braking torque target FD-1 and the second dissipative braking torque target FD1, when present, is a pressure value of the braking fluid.

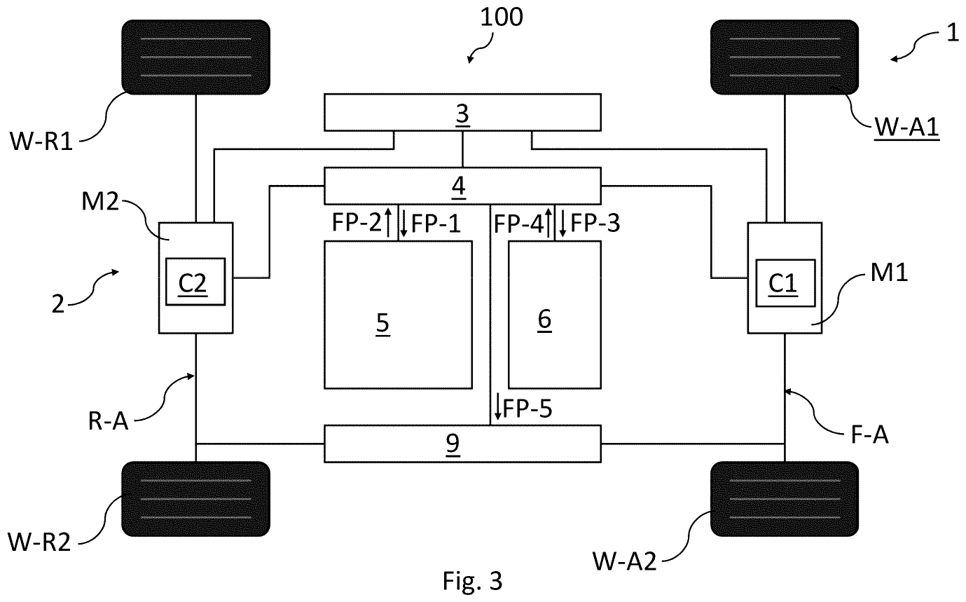

According to a further embodiment, as an alternative to the preceding ones and shown in FIG. 3, the system 100 further comprises a dissipation module 9 operatively connected to the power management unit 4.

The dissipation module 9 is configured to be operatively connected to the at least one first axle F-A.

In this embodiment, in addition to providing instructions I-C for conveying a first electric power flow FP-1 entering in the first battery pack 5 of high-energy cells, a second electric power flow FP-2 leaving the first battery pack 5 of high-energy cells, a third electric power flow FP-3 entering in the second battery pack 6 of high-power cells, and a fourth electric power flow FP-4 leaving the second battery pack 6 of high-power cells, and controlling the first electric power flow FP-1, the second electric power flow FP-2, the third electric power flow FP-3, and the fourth electric power flow FP-4, the power management unit 4 is configured to provide further instructions UI-C for conveying a respective fifth electric power flow FP-5 entering in the dissipation module 9 and a respective sixth electric power flow FP-6 leaving the dissipation module 9 and, optionally, control the fifth electric power flow FP-5 based on said first input information I1, the at least one second input information I2, said third input information I3 and the further input information 14.

Due to the electrical resistivity thereof, the dissipation module 9, for example a resistor, crossed by an electric power, therefore by an electric current, is capable of dissipating energy into heat due to the Joule effect.

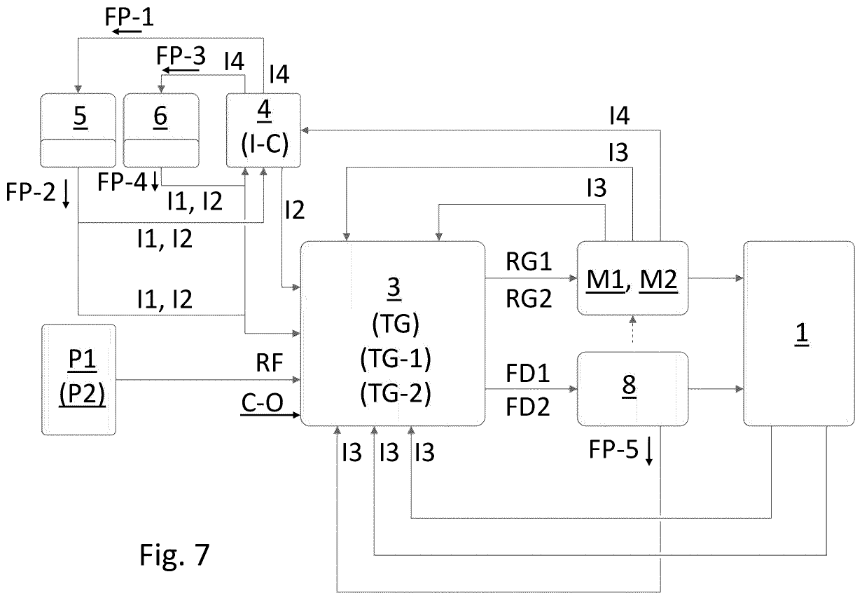

With reference to the more general embodiment shown in FIG. 1, in which the vehicle 1 comprises at least one first axle F-A and the braking/driving system 2 of the vehicle 1 comprises the at least one first electric motor M1, and in which the system 100 does not have a dissipative braking torque actuation module or a dissipation module, and also referring in particular to the diagram in FIG. 7, an operating example of the system 100 for managing the electric power flow in battery packs of an electric or hybrid vehicle 1 is now described.

An electronic control unit 3 of the system 100 for managing the electric power flow in battery packs of an electric or hybrid vehicle receives a braking request RF imparted, for example, by a driver P1 by means of a brake pedal of the vehicle 1.

The electronic control unit 3 receives the at least one piece of information C-O representative of an operating condition of the vehicle 1, for example, information concerning a deceleration of the vehicle 1.

Then the electronic control unit 3 receives first input information I1 representative of a condition of correct operation (“state of health”) of a first battery pack 5 of high-energy cells and a second battery pack 6 of high-power cells of the system 100.

The first input information I1 was defined and described above.

The electronic control unit 3 receives at least one second information I2 representative of an electric power regenerated inside the system 100.

The at least one second input information I2 is provided by a power management unit 4 of the system 100 operatively connected to the electronic control unit 3.

The electronic control unit 3 receives third input information I3 representative of a regenerative braking or driving phase carried out by the system 100 on the braking/driving system 2 of the vehicle 1.

The third input information I3 was defined and described above.

The power management unit 4 of the system 100 receives a further input information 14 representative of an electric power regenerated by the at least one first electric motor M1.

The electronic control unit 3 determines a target braking or driving value TG to be imparted to the vehicle 1, based on said braking request RF and, when present, on the at least one piece of information C-O representative of an operating condition of the vehicle 1.

The determined target braking or driving value TG to be imparted to the vehicle 1 comprises at least one first regenerative braking or driving torque target RG-1 of the at least one first axle F-A.

The electronic control unit 3 defines the at least one first regenerative braking or driving torque target RG-1 to be imparted to the at least one first electric motor M1 operatively connected to the at least one first axle F-A of the vehicle 1 based on said first input information I1, the at least one second input information I2, and said third input information I3.

The power management unit 4 provides instructions I-C for conveying a first electric power flow FP-1 entering in the first battery pack 5 of high-energy cells, a second electric power flow FP-2 leaving the first battery pack 5 of high-energy cells, a third electric power flow FP-3 entering in the second battery pack 6 of high-power cells, and a fourth electric power flow FP-4 leaving the second battery pack 6 of high-power cells.

The power management unit 4 controls the first electric power flow FP-1, the second electric power flow FP-2, the third electric power flow FP-3, and the fourth electric power flow FP-4 based on said first input information I1, the at least one second input information I2, said third input information I3, and the further input information 14.

Therefore, based on the state of health and charge of the first battery pack 5 and the second battery pack 6 and based on the current braking condition, the power management unit 4 is capable of delivering the electric power from/to the first battery pack 5 of high-energy cells or from/to the second battery pack 6 of high power cells.

The control of the flows leaving the first battery pack 5 of high-energy cells and the second battery pack 6 of high-power cells is important for controlling the driving phase of the vehicle 1.

As can be seen, the object of the present invention is fully achieved.

Indeed, the system and method of the present invention allow recovering all the braking power, thus maximizing the range of use of the vehicle and minimizing the pollution from fine dust due to the use of the friction brake without incurring an oversizing of the first battery pack 5 of high-energy cells.

The proposed system comprises one or more electric motors connected to one or more wheels or front or rear axles of the vehicle.

Based on the regenerative braking or driving torque targets received from an electronic control unit of the vehicle (VCU), each electric motor control module controls the driving torque and/or braking torque of the vehicle, for example, by conveniently regulating the supply voltage of the respective electric motor.

The second battery pack 6 of high-power cells allows absorbing the braking power peaks that the high-energy battery back is not capable of accepting.

During the driving phase, the second battery pack 6 of high-power cells instead transfers electricity to the first battery pack 5 of high-energy cells while respecting the maximum current limits that the latter are capable of absorbing, or they transfer energy directly to the electric motors, supporting the first high-energy battery pack during the driving phase.

The electronic control unit is configured to process the braking or driving request imparted by the driver by reading a pump pressure signal and/or pedal stroke, transform it into a braking torque target for front axle and rear axle and, according to the state of charge and the state of the batteries, conveniently distribute a braking or driving torque request to the electric motors, as a regenerative braking or driving torque, and to the possible dissipation module, as a dissipative braking torque.

In order to meet contingent needs, those skilled in the art may make changes and adaptations to the embodiments of the system described above, and replace elements with others which are functionally equivalent, without departing from the scope of the following claims. Each of the features described as belonging to a possible embodiment can be achieved irrespective of the other embodiments described.

1-9. (canceled)

10. A system for managing the electric power flow in battery packs of an electric or hybrid vehicle, comprising:
an electronic control unit of the vehicle, the electronic control unit being configured to be operatively connected to at least one first electric motor of a braking/driving system of the vehicle operatively connected to at least one first axle of the vehicle, the electronic control unit being configured to control the at least one first electric motor;
a power management unit operatively connected to the electronic control unit, the power management unit being configured to be operatively connected to the at least one first electric motor;
a first battery pack of high-energy cells operatively connected to the power management unit, the first battery pack of high-energy cells being configured to store electricity during a braking phase of the vehicle to be supplied to the at least one first electric motor during a driving phase of the vehicle;
a second battery pack of high-power cells operatively connected to the power management unit, the second battery pack of high-power cells being configured to store electricity from electric power peaks of regenerative braking;
the electronic control unit being configured to:
receive a braking or driving request;
receive first input information representative of a condition of correct operation of the first battery pack of high-energy cells and the second battery pack of high-power cells;
receive at least one second input information representative of an electric power regenerated inside the system, the at least one second input information being provided by the power management unit;
1 receive third input information representative of a regenerative braking or driving phase carried out by the system on the braking/driving system;
determine a target braking or driving value to be imparted to the vehicle based on said braking or driving request, the determined target braking or driving value to be imparted to the vehicle comprising at least one first regenerative braking or driving torque target to be imparted to the at least one first axle;
define the at least one first regenerative braking or driving torque target to be imparted to the at least one first electric motor operatively connected to the at least one first axle based on said first input information, the at least one second input information, and said third input information;
the power management unit being configured to:
receive a further input information representative of an electric power regenerated by the at least one first electric motor;
provide instructions for conveying a first electric power flow entering in the first battery pack of high-energy cells, a second electric power flow leaving the first battery pack of high-energy cells, a third electric power flow entering in the second battery pack of high-power cells, and a fourth electric power flow leaving the second battery pack of high-power cells, and control the first electric power flow, the second electric power flow, the third electric power flow, and the fourth electric power flow based on said first input information, the at least one second input information, said third input information, and the further input information.

11. The system according to claim 10, wherein the electronic control unit is configured to receive at least one piece of information representative of an operating condition of the vehicle, the electronic control unit being configured to determine the target braking or driving value to be imparted to the vehicle based on said braking or driving request and the at least one piece of information representative of an operating condition of the vehicle.

12. The system according to claim 10, wherein the electronic control unit comprises a first braking or driving torque division management sub-module, the first braking or driving torque division management sub-module being configured to define the at least one first regenerative braking torque target from the target braking or driving value to be imparted to the at least one first axle.

13. The system according to claim 12, further comprising a dissipative braking torque actuation module operatively connected to the electronic control unit, the dissipative braking torque actuation module being configured to be operatively connected to the at least one first axle, the electronic control unit being configured to divide the target braking or driving value to be imparted to the at least one first axle into the first regenerative braking or driving torque target to be imparted to the at least one first axle by means of the at least one first electric motor, and into a first dissipative braking torque target to be imparted to the first front axle by means of the dissipative braking torque actuation module.

14. The system according to claim 13, wherein the division of the target braking or driving value to be imparted to the at least one first axle into the at least one first regenerative braking or driving torque target and into the first dissipative braking torque target is performed by the first braking torque division management sub-module.

15. The system according to claim 14, wherein the dissipative braking torque actuation module comprises one or more braking modules with B-b-W technology.

16. The system according to claim 14, wherein the dissipative braking torque actuation module comprises a braking module with B-b-W technology or one or more parasitic electric current brakes configured to be operatively connected to the at least one first axle and/or at least one first wheel.

17. The system according to claim 14, wherein the power management unit is configured to provide further instructions for conveying a respective fifth electric power flow entering in the dissipative braking torque actuation module by means of the electronic control unit, and optionally control the fifth electric power flow based on said first input information, the at least one second input information, said third input information, and the further input information.

18. The system according to claim 10, further comprising a dissipation module operatively connected to the power management unit, the dissipation module being configured to be operatively connected to the at least one first axle, the power management unit being configured to provide further instructions for conveying a respective fifth electric power flow entering in the dissipation module, and optionally control the fifth electric power flow based on said first input information, the at least one second input information, said third input information, and the further input information.
